(19) United States
(12) Patent Application Publication
(10) Pub. No.: US 2024/0381333 A1
(43) Pub. Date: Nov. 14, 2024

(54) INFORMATION TRANSMISSION METHOD, DEVICE, TERMINAL, AND NETWORK SIDE DEVICE

(71) Applicant: VIVO MOBILE COMMUNICATION CO., LTD., Dongguan (CN)

(72) Inventor: Lei JIANG, Dongguan (CN)

(73) Assignee: VIVO MOBILE COMMUNICATION CO., LTD., Dongguan (CN)

(21) Appl. No.: 18/784,893

(22) Filed: Jul. 25, 2024

Related U.S. Application Data
(63) Continuation of application No. PCT/CN2023/073292, filed on Jan. 20, 2023.

(30) Foreign Application Priority Data
Jan. 26, 2022 (CN) 202210095380.6

(51) Int. Cl. H04W 72/0453; H04L 27/26; H04W 72/12; H04W 72/231; H04W 76/20

(52) U.S. Cl. CPC H04W 72/0453; H04L 27/2605; H04W 72/12; H04W 72/231; H04W 76/20

(57) ABSTRACT

An information transmission method, a terminal, and a non-transitory computer-readable storage medium are provided. The information transmission method includes: receiving by the terminal, first information from a network side device. The first information includes a configuration of at least one subband.

### CROSS-REFERENCE TO RELATED APPLICATIONS

The present application is a continuation of International Application No. PCT/CN2023/073292, filed on Jan. 20, 2023, which claims priority to Chinese Patent Application No. 202210095380.6, filed on Jan. 26, 2022. The entire contents of each of the above-referenced applications are expressly incorporated herein by reference.

### TECHNICAL FIELD

This application relates to the field of mobile communication technologies, and specifically, to an information transmission method, a device, a terminal, and a network side device.

### BACKGROUND

In a related technology, a network side device configures a BandWidth Part (BWP) or a carrier for a terminal (also referred to as User Equipment (UE)) for data transmission, and the allocated BWP uses determined UpLink (UL) resources and Downlink (DL) resources.

The uplink resources and the downlink resources in the BWP are allocated through Time Division Duplex (TDD) based on a UL/DL ratio. However, because an uplink service and a downlink service are not symmetrical, in some scenarios, a UL service volume is greater than a DL service volume. However, in some other scenarios, a DL service volume is greater than a UL service volume. For example, when a DL service volume of an entire system is large, DL resources become scarce, but there are more idle UL resources with low utilization efficiency, resulting in low utilization efficiency of system resources.

### SUMMARY

Embodiments of this application provide an information transmission method, a device, a terminal, and a network side device.

According to a first aspect, an information transmission method is provided. The method is applied to a terminal and includes:

The terminal receives first information from a network side device, where the first information includes a configuration of at least one subband.

According to a second aspect, an information transmission apparatus is provided, including:

a transceiver module, configured to receive first information from a network side device; and

a configuration module, configured to configure at least one subband based on the first information.

According to a third aspect, an information transmission method is provided. The method is applied to a network side device and includes:

The network side device sends first information to a terminal, where the first information is used to configure a configuration of at least one subband for the terminal.

According to a fourth aspect, an information transmission apparatus is provided, including:

an execution module, configured to determine first information, where the first information is used to configure a configuration of at least one subband for the terminal; and

a sending module, configured to send first information to a terminal.

According to a fifth aspect, a terminal is provided. The terminal includes a processor and a memory, the memory stores a program or an instruction that can be run on the processor, and when the program or the instruction is executed by the processor, the steps of the method according to the first aspect are implemented.

According to a sixth aspect, a terminal is provided, including a processor and a communication interface. The processor is configured to configure at least one subband based on first information, and the communication interface is configured to receive first information from a network side device.

According to a seventh aspect, a network side device is provided. The network side device includes a processor and a memory, the memory stores a program or an instruction that can be run on the processor, and when the program or the instruction is executed by the processor, the steps of the method according to the third aspect are implemented.

According to an eighth aspect, a network side device is provided, including a processor and a communication interface. The processor is configured to determine first information, where the first information is used to configure a configuration of at least one subband for a terminal, and the communication interface is configured to send first information to the terminal.

According to a ninth aspect, an information transmission system is provided, including a terminal and a network side device. The terminal may be configured to perform the steps of the information transmission method according to the first aspect, and the network side device may be configured to perform the steps of the information transmission method according to the third aspect.

According to a tenth aspect, a readable storage medium is provided. The readable storage medium stores a program or an instruction, and when the program or the instruction is executed by a processor, the steps of the method according to the first aspect are implemented, or the steps of the method according to the third aspect are implemented.

According to an eleventh aspect, a chip is provided. The chip includes a processor and a communication interface. The communication interface is coupled to the processor, and the processor is configured to run a program or an instruction, to implement the method according to the first aspect or the method according to the third aspect.

According to a twelfth aspect, a computer program/program product is provided. The computer program/program product is stored in a storage medium, and the program/program product is executed by at least one processor to implement the information transmission method according to the first aspect, or to implement the steps of the information transmission method according to the third aspect.

In the embodiments of this application, the network side device configures the configuration of the at least one subband for the terminal by using the first information. The at least one subband supports separately carrying uplink transmission and downlink transmission at a same time, so that the network side device can separately implement uplink transmission and downlink transmission with a plurality of terminals simultaneously, thereby improving resource utilization efficiency.

### BRIEF DESCRIPTION OF DRAWINGS

FIG. 1 is a diagram of a structure of a wireless communication system to which embodiments of this application may be applied;

FIG. 2 is a schematic flowchart of an information transmission method according to an embodiment of this application;

FIG. 3 is a schematic flowchart of another information transmission method according to an embodiment of this application;

FIG. 4 is a diagram of a configuration of a subband according to an embodiment of this application;

FIG. 5 is a diagram of another configuration of a subband according to an embodiment of this application;

FIG. 6 is a diagram of a structure of an information transmission apparatus according to an embodiment of this application;

FIG. 7 is a schematic flowchart of another information transmission method according to an embodiment of this application;

FIG. 8 is a diagram of a structure of another information transmission apparatus according to an embodiment of this application;

FIG. 9 is a diagram of a structure of a communication device according to an embodiment of this application;

FIG. 10 is a diagram of a structure of a terminal according to an embodiment of this application; and

FIG. 11 is a diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

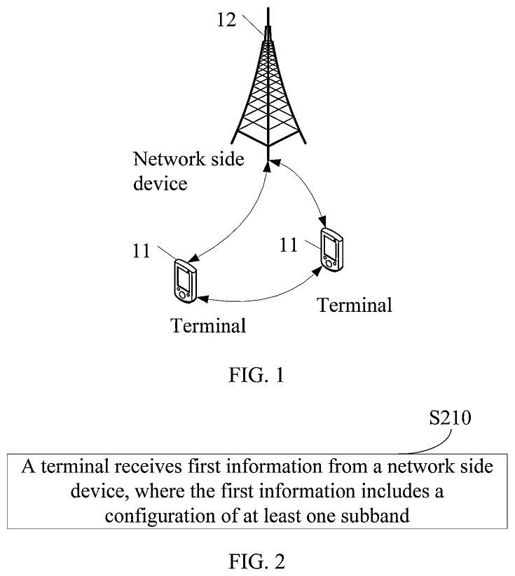

FIG. 1 shows a block diagram of a wireless communication system to which embodiments of this application may be applied. The wireless communication system includes terminals 11 and a network side device 12. Each of the terminals 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), or a smart home (a home device with a wireless communication function, such as a refrigerator, a television, a washing machine, or furniture), a game console, a Personal Computer (PC), a teller machine, a self-service machine, or the like. The wearable device includes a smart watch, a smart band, a smart headset, smart glasses, smart jewelry (a smart bracelet, a smart chain bracelet, a smart ring, a smart necklace, a smart anklet, a smart chain anklet, or the like), a smart wrist strap, smart clothing, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a Wireless Local Area Network (WLAN) access node, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the art. As long as a same technical effect is achieved, the base station is not limited to a specified technical term. It should be noted that, in the embodiments of this application, only a base station in an NR system is used as an example for description, but a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server

Discovery Function (EASDF), Unified Data Management (UDM), Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

The following describes in detail the information transmission method provided in the embodiments of this application through some embodiments and application scenarios thereof with reference to the accompanying drawings.

As shown in FIG. 2, an embodiment of this application provides an information transmission method. The method may be performed by a terminal. In other words, the method may be performed by software or hardware installed in the terminal. The method may include the following step.

S210: The terminal receives first information from a network side device, where the first information includes a configuration of at least one subband. It should be understood that the subband may be a resource set in a BWP or a carrier, or may be referred to as a Resource Block (RB) set. However, for simplicity, the subband is used as an example in each of the following embodiments for description.

When the network side device sends the first information to the terminal, the configuration of the at least one subband included in the first information may be for different objects. In an implementation, each terminal corresponds to a respective configuration of the at least one subband of the terminal. That is, the configuration of the at least one subband may be separately configured for each terminal.

In another implementation, each bandwidth part corresponds to a respective configuration of the at least one subband of the bandwidth part. That is, the configuration of the at least one subband may be separately configured for each BWP.

In another implementation, each cell corresponds to a respective configuration of the at least one subband of the cell. That is, the configuration of the at least one subband may be separately configured for each cell, or the configuration of the at least one subband is configured for a terminal of each cell.

The network side device may configure a plurality of pieces of configuration information for the terminal according to an actual requirement. In an implementation, the configuration of the at least one subband includes at least one of the following:

the number of subbands;

frequency domain information of each subband;

frequency domain information of a guard band between adjacent subbands;

an uplink/downlink configuration or a subframe format of each subband; and

information about a combination of subbands.

It should be understood that the frequency domain information of the subband and the frequency domain information of the guard band may be represented in a plurality of manners, and may include at least one of the following:

a bandwidth or granularity;

a start position in frequency domain; and an end position in frequency domain.

It should be understood that each of the foregoing configurations may include only one value or one group of values, or may include a plurality of values or a plurality of groups of values.

The number of subbands configured by the network side device for the terminal may be one value, for example, 3, or a plurality of values may be configured, for example, {2, 3, 5}. For example, a plurality of quantities of subbands are configured, which are 2, 3, and 5 respectively.

The frequency domain information of each subband configured by the network side device for the terminal may be represented by using a bandwidth or granularity of frequency domain. For example, a bandwidth of each subband may be configured to 20 MHz. In some alternative embodiments, one bandwidth set including a plurality of bandwidths may be configured for each subband, for example, {10 MHz, 20 MHz, 30 MHz}, and each subband may select a specified bandwidth or any bandwidth from the bandwidth set. In some alternative embodiments, a bandwidth of each subband is separately configured, for example, {10 MHz, 20 MHz, and 30 MHz}, which indicates that three subbands are configured, and bandwidths of the three subbands are 10 MHz, 20 MHz, and 30 MHz respectively. The frequency domain information of the subband may be determined by using a start position in frequency domain and/or an end position in frequency domain, for example, may be represented in a manner of {start position, end position}, or {start position, bandwidth}.

The frequency domain information of the guard band between adjacent subbands configured by the network side device for the terminal may be represented by using a bandwidth. For example, a bandwidth of each guard band may be configured to 5 MHz. In some alternative embodiments, a plurality of bandwidths are configured for each guard band or a plurality of guard bands are configured, for example, {5 MHZ, 2.5 MHz}. In some alternative embodiments, a combination of a plurality of guard bands is configured {{5 MHZ, 2.5 MHz}, {2.5 MHz, 2.5 MHz, 2.5 MHz}}. The frequency domain information of the guard band may be determined by using a start position in frequency domain and/or a terminal position in frequency domain, for example, may be represented in a manner of {start position, end position}, or {start position, bandwidth}.

It should be understood that the frequency domain information of the subband and the frequency domain information of the guard band may be referred to a BWP or a carrier in which the subband or the guard band is located. For example, a start position that is of a first configured subband and that is in frequency domain may be based on a start position that is of the BWP or the carrier and that is in frequency domain, and an end position that is of a last configured subband and that is in frequency domain may be based on an end position that is of the BWP or the carrier and that is in frequency domain.

The information about the combination of subbands configured by the network side device for the terminal includes a combination of information about configurations of one subband group or a plurality of subband groups. In an implementation, frequency domain information of each subband in the subband group may be included, for example, a bandwidth of each subband. For example, the information about the combination of subbands may include one subband group {20 MHz, 20 MHz, 20 MHz}. In some alternative embodiments, a plurality of other subband groups {30 MHz, 10 MHZ, 20 MHz, 10 MHZ, 20 MHz}, {10 MHZ, 30 MHz}, {30 MHz}, and the like, may further be configured. The information about the combination of subbands may be configured by using an index value corresponding to each subband. For example, the information about the combination of subbands may be represented by using index values corresponding to a plurality of bandwidths of a configured subband. If the bandwidths of the configured subband is {10 MHZ, 20 MHz, 30 MHz}, and an index value corresponding to each of the bandwidths is 1, 2, and 3 respectively, the information about the combination of subbands may be represented as {{2, 2, 2}, {3, 1, 2, 1, 2}, {1, 3}, {3}}.

In another implementation, the information about the combination of subbands may be represented by using frequency domain information of one guard band group or frequency domain information of a plurality of guard band groups. For example, that information about a combination of guard bands is {5 MHz, 5 MHz} indicates that an allocated bandwidth is divided into three parts on the allocated bandwidth, that is, on a BWP or a carrier in which the guard bands are located, and a bandwidth of a guard band between every two adjacent subbands is 5 MHz. A start position that is of a first subband and that is in frequency domain is a start position that is of the BWP or the carrier and that is in the frequency domain, and an end position that is of a last subband in frequency domain is an end position that is of the BWP or the carrier and that is in frequency domain. The information about the combination of subbands may be configured by using an index value corresponding to each guard band, for example, may be represented by using index values corresponding to a plurality of bandwidths of a configured guard band. A manner is the same as that of the index value corresponding to the bandwidth. Details are not described herein again.

The uplink/downlink configuration or the subframe format of each subband configured by the network side device for the terminal may include a transmission direction supported by each subband at each moment, and may support uplink transmission, downlink transmission, or a flexible configuration manner, so that at least one configured subband may support both uplink transmission and downlink transmission at some moments. That is, at some moments, there are both a subband used to carry uplink transmission and a subband used to carry downlink transmission.

It should be understood that the at least one subband included in the first information supports separately carrying uplink transmission and downlink transmission at a same time. In an implementation, when the network side device configures a plurality of subbands for the terminal by using the first information, at a same moment, the network side device may send downlink information to a terminal by using one or more subbands, and may receive, by using another subband, uplink information sent by a terminal. The terminal configured to receive the downlink information and the terminal configured to send the uplink information may be different terminals, or may be a same terminal.

In another implementation, when the network side device configures one subband for the terminal by using the first information, at a same moment and on the subband, the network side device may both send downlink information to a terminal and receive uplink information sent by the terminal. On the subband, the terminal may both receive the downlink information sent by the network side device and send the uplink information to the network side device.

After receiving configuration information of the at least one subband, each terminal may respectively determine an available subband and a transmission resource based on a related indication. If the terminal needs to send uplink data, the terminal determines, from the available subband, a resource that can be used for uplink transmission. In some alternative embodiments, if the terminal needs to receive downlink data, the terminal determines, from the available subband, a resource that can be used for downlink transmission.

It can be learned from the technical solutions in the foregoing embodiment that, the network side device in this embodiment of this application configures the configuration of the at least one subband for the terminal by using the first information. The at least one subband supports separately carrying uplink transmission and downlink transmission at a same time, so that the network side device can separately implement uplink transmission and downlink transmission with a plurality of terminals simultaneously, thereby improving resource utilization efficiency and reducing a reply delay of data.

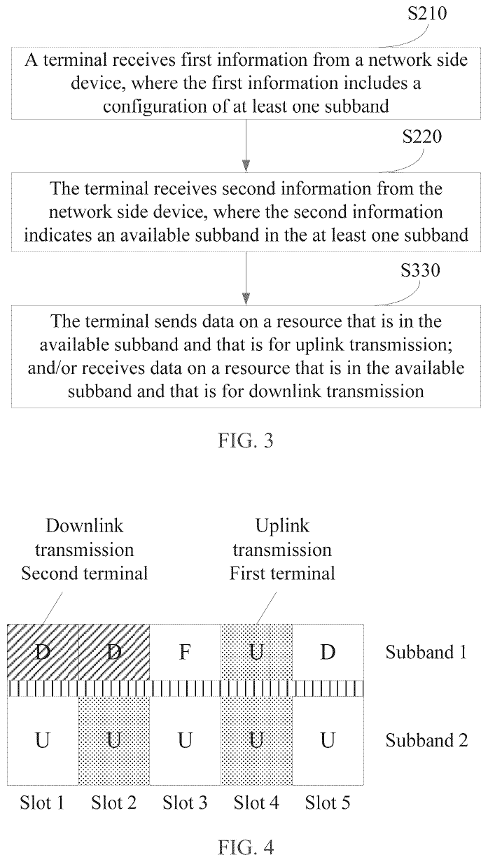

Based on the foregoing embodiment, further, as shown in FIG. 3, after S210, the method further includes the following step.

S220: The terminal receives second information from the network side device, where the second information indicates an available subband in the at least one subband.

The network side device may send the second information to the terminal, and specify an available subband of the terminal and a configuration of the available subband from the at least one subband configured for the terminal. In an implementation, the second information includes at least one of the following:

first indication information indicating the number of available subbands;

second indication information indicating frequency domain information of the available subbands;

third indication information indicating frequency domain information of a guard band between adjacent subbands in the available subbands;

fourth indication information indicating an uplink/downlink configuration or a subframe format of each of the available subbands; and

fifth indication information indicating information about a combination of the available subbands.

It should be understood that the frequency domain information of the available subbands and the frequency domain information of the guard band between adjacent subbands in the available subbands may be represented in a plurality of manners, and may include at least one of the following:

a bandwidth or granularity;

a start position in frequency domain; and

an end position in frequency domain.

The second information may include the first indication information and the second indication information, which respectively indicate the number of available subbands and the frequency domain information of the available subbands. For example, if the first indication information indicates that a quantity of the available subbands is 3, and the second indication information indicates that a bandwidth of each of the available subbands is 20 MHz, the terminal has three available subbands, and a bandwidth of each of the available subbands is 20 MHz.

The second information may include the fifth indication information, which indicates the information about the combination of the available subbands. For example, if the information about the combination indicated by the fifth indication information is {10 MHz, 30 MHz}, the terminal has two available subbands, and bandwidths of the two available subbands are 10 MHz and 20 MHz respectively.

The second information may include the first indication information and the third indication information, which respectively indicate the number of available subbands and the frequency domain information of the guard band between adjacent subbands in the available subbands. For example, if the first indication information indicates that the number of the available subbands is 3, and the third indication information indicates that the frequency domain information of the guard band is 5 MHZ, the terminal has three available subbands, and a bandwidth of the guard band between every two available subbands is 5 MHz.

The fifth indication information of the second information may indicate the information about the combination of the available subbands by using frequency domain information of one guard band group. For example, if the fifth indication information indicates that a bandwidth of the guard band is {5 MHZ, 2.5 MHz}, the terminal has three available subbands, where a bandwidth of a guard band between a first available subband and a second available subband is 5 MHz, and a bandwidth of a guard band between the second available subband and a third available subband is 2.5 MHz. For another example, the guard band may be represented as {15 MHz, 17.5 MHz} by using {start position in frequency domain, end position in frequency domain}. When a BWP is a 40 MHz bandwidth, the terminal has two available subbands, a bandwidth of a first available subband is 15 MHZ, and a bandwidth of a second available subband is 22.5 MHz.

The uplink/downlink configuration or the subframe format indicated by the second information may indicate a transmission direction supported by each of the available subbands at each moment, and may be configured as a semi-static TDD UL/DL configuration, or may be dynamically configured in a manner similar to that of a Slot Format Indicator (SFI).

The second information may indicate a value of each of the first indication information to the fifth indication information, or may indicate an index of a configuration that corresponds to each of the first indication information to the fifth indication information and that is in the first information.

As shown in FIG. 4, the network side device configures two subbands for each terminal by using the first information, including a subband 1 and a subband 2. Bandwidths of the two subbands are different, and there is a guard band between the two subbands. The network side device separately indicates information about an available subband to each of a first terminal and a second terminal by using the second information, so that the first terminal and the second terminal each determine a resource that can be used for transmission, that is, as shown in FIG. 4. Available subbands of the first terminal are the subband 1 and the subband 2, and an available subband of the second terminal is the subband 1. In addition, the second information further indicates the uplink/downlink configuration or the subframe format of each of the available subbands. For example, the indication may be performed in a unit of a slot or a symbol. As shown in FIG. 4, transmission directions of each subband in different slots are different. U indicates uplink transmission, D indicates downlink transmission, and F indicates a flexible configuration. The second terminal detects downlink transmission in a slot 1 and a slot 2 and on the subband 1 based on scheduling of a base station, and the first terminal performs uplink transmission in the slot 2 and on the subband 2, and in a slot 4 and on the subband 1 and the subband 2 based on scheduling.

S230: The terminal sends data based on a resource that is in the available subband and that is for uplink transmission, or receives data based on a resource that is in the available subband and that is for downlink transmission.

As shown in FIG. 5, the network side device configures three subbands with a same bandwidth for each terminal by using the first information, including a subband 1, a subband 2, and a subband 3. The network side device indicates an available subband for each terminal by using the second information. For example, the network side device indicates to the first terminal that available subbands are the subband 1, the subband 2, and the subband 3, and indicates to the second terminal that an available subband is the subband 2. As shown in FIG. 5, the second information further indicates an uplink/downlink configuration of each subband in each slot. U represents uplink transmission, D represents downlink transmission, and F represents a flexible configuration. A first terminal and a second terminal each determine an available resource at each moment based on information such as an uplink/downlink configuration of each subband and scheduling or configuration of data by the network side device. In a slot 1 and a slot 2, the second terminal receives downlink data on the subband 2. In the slot 2, the first terminal simultaneously sends uplink data on the subband 3. In a slot 4, the first terminal sends uplink data on the subbands 1 to 3. In a slot 5, the second terminal receives downlink data on the subband 2.

It can be learned from the technical solutions in the foregoing embodiment that, the network side device in this embodiment of this application indicates the information about the available subband to the terminal by using the second information, so that the terminal sends the data based on the resource that is in the available subband and that is for uplink transmission, or receives the data based on the resource that is in the available subband and that is for downlink transmission. Therefore, the network side device can separately implement uplink transmission and downlink transmission with a plurality of terminals simultaneously, thereby improving resource utilization efficiency and reducing a reply delay.

Based on the foregoing embodiment, further, the second information is carried in at least one of the following:

a Radio Resource Control (RRC) message; and

Downlink Control Information (DCI).

Based on the configuration of the at least one subband configured by the network side device for the terminal by using the first information, in an implementation, the network side device may indicate the information about the available subband to the terminal by using only one RRC message. For example, the network side device indicates, to the terminal by using one RRC message, at least one of the following: the number of available subbands, frequency domain information of the available subbands, frequency domain information of a guard band between adjacent subbands in the available subbands, an uplink/downlink configuration or a subframe format of each of the available subbands, and information about a combination of the available subbands.

In another implementation, the network side device may indicate the information about the available subband to the terminal by using only one piece of DCI. For example, the network side device indicates, to the terminal by using one piece of DCI, at least one of the following: the number of available subbands, frequency domain information of the available subbands, frequency domain information of a guard band between adjacent subbands in the available subbands, an uplink/downlink configuration or a subframe format of each of the available subbands, and information about a combination of the available subbands.

In another implementation, the network side device may separately indicate some configuration information of the available subband to the terminal by using one RRC message and one piece of DCI. For example, the network side device indicates the number of available subbands by using one RRC message, and indicate, by using one piece of DCI, at least one of the following: frequency domain information of the available subbands, frequency domain information of a guard band between adjacent subbands in the available subbands, an uplink/downlink configuration or a subframe format of each of the available subbands, and information about a combination of the available subbands. In some alternative embodiments, the network side device indicates, by using an RRC message, the number of available subbands and/or an uplink/downlink configuration or a subframe format of each of the available subbands, and indicates, by using one piece of DCI, at least one of the following: frequency domain information of the available subbands, frequency domain information of a guard band between adjacent subbands in the available subbands, and information about a combination of the available subbands.

In another implementation, the network side device may separately indicate some configuration information of the available subband to the terminal by using a plurality of pieces of DCI. For example, the network side device indicates, by using first DCI, at least one of the following: the number of available subbands, frequency domain information of the available subbands, frequency domain information of a guard band between adjacent subbands in the available subbands, and information about a combination of the available subbands; and indicates, by using second DCI, an uplink/downlink configuration or a subframe format of each of the available subbands.

In another implementation, the network side device may separately indicate some configuration information of the available subband to the terminal by using one RRC message and a plurality of pieces of DCI. For example, the network side device indicates the number of available subbands by using one RRC message; indicates, by using first DCI, at least one of the following: frequency domain information of the available subbands, frequency domain information of a guard band between adjacent subbands in the available subbands, and information about a combination of the available subbands; and indicates, by using second DCI, an uplink/downlink configuration or a subframe format of each of the available subbands.

In an implementation, when the network side device configures a subband for the terminal by using the first information, if any piece of configuration information configured includes only one value or a group of values, the network side device may directly indicate the configuration information to the terminal by using an RRC message. In this case, the second information is equal to the first information. For example, if the number of subbands configured for the terminal by using the first information is 3, a bandwidth of the subband is 20 MHz, and one uplink/downlink configuration is performed, the network side device may directly indicate to the terminal by using the RRC message, that the number of available subbands is 3, and a bandwidth of the available subbands is 20 MHz, and each of the available subbands is configured with a same uplink/downlink configuration.

In another implementation, when the network side device configures a subband for the terminal by using the first information, if any piece of configuration information includes a plurality of values or a plurality of groups of values, the network side device may indicate, to the terminal by using DCI, one value or a group of values from the plurality of values or the plurality of groups of values for the configuration information. For example, if the information about the combination of subbands configured for the terminal by using the first information includes {{20 MHz, 20 MHz, 20 MHz}, {30 MHz, 10 MHZ, 20 MHz, 10 MHZ, 20 MHz}, {10 MHZ, 30 MHz}, {30 MHz}}, the network side device may indicate information about any combination of the subbands to the terminal by using DCI as the information about the combination of the available subbands. If DCI indicates an index 3, {10 MHz, 30 MHz} is used as the information about the combination of the available subbands of the terminal, the terminal has two available subbands, and bandwidths of the two available subbands are 10 MHz and 30 MHz respectively.

When any piece of configuration information includes a plurality of values or a plurality of groups of values, it may be equivalent to that a plurality of pieces of configuration information are configured, and the second information indicates one piece of configuration information to the terminal from the plurality of pieces of configuration information. For example, a bandwidth of a subband configured by the network side device by using the first information is {10 MHz, 20 MHz, and 30 MHz}. It is equivalent to configuring three subbands whose bandwidths are 10 MHZ, 20 MHz, and 30 MHz respectively. If the second information indicates that a bandwidth of a subband is 20 MHz, it is equivalent to indicating to the terminal, from the configured three subbands, that the subband whose bandwidth is 20 MHz is the available subband.

In another implementation, indication information of the second information is respectively carried in a plurality of signaling messages, for example, a plurality of pieces of DCI. For example, one or more of the first indication information, the second indication information, the third indication information, the fourth indication information, and the fifth indication information that are included in the second information may be indicated by using one piece of DCI, or may be respectively indicated by using different pieces of DCI. For example, the network side device configures four combinations of subbands for the terminal by using the first information, and four groups of SFIs. Each group of SFIs may separately indicate a subframe format of each subband in one combination of subbands. Each combination of subbands is in a one-to-one correspondence with an SFI index. In this case, the network side device may indicate, by using DCI, one SFI index or one combination of subbands, so that the network side device may indicate both information about a combination of the available subbands and an SFI corresponding to the available subband. When each combination of subbands does not correspond to an SFI index, the network side device may respectively indicate one SFI index and one combination of subbands by using two pieces of DCI, or respectively indicate one SFI index and one combination of subbands by using two fields in one piece of DCI.

In an implementation, configuration information that is not pre-configured by the network side device is not required to be indicated in the second information. For example, if the network side device does not configure the number of subbands for the terminal, the second information does not need to indicate the number of available subbands.

That the uplink/downlink configuration or the subframe format of each of the available subbands is indicated by using the second information may include indicating a transmission direction of a time-frequency domain resource in the available subbands. An indication manner may be various. This embodiment of this application provides only one implementation, in which the transmission direction of the time-frequency resource is indicated in a two-dimensional manner. A size of the indicated time-frequency resource in time domain and frequency domain is fixed, and a time domain length of the time-frequency resource may be considered as an indication period. A fixed quantity of bits is used for indication. Each bit indicates a transmission direction of a time-frequency resource block, and granularity of a time-frequency resource represented by each bit changes based on a configuration. For example, an M*N bit indicates a time-frequency resource, where M represents the number of subbands in frequency domain, N implicitly indicates granularity of time domain, and M and N may change based on indication of another parameter. However, in an indication process, a value of M*N remains unchanged. For example, for a time-frequency resource with a bandwidth of 80 MHz and 14 slots, M*N=56. When the network side device indicates that the number of available subbands of the terminal is M=4, then N=14, and each bit indicates a transmission direction of a time-frequency resource on a 20 MHz subband in one slot. If the network side device indicates that the number of available subbands of the terminal is M=2, then N=28, so that a total quantity of bits remains unchanged and is still 56. When fixed duration is considered to be 14 slots, each bit represents ½ slot, that is, a transmission direction of a time-frequency resource on a 40 MHz subband in seven Orthogonal Frequency Division Multiplexing symbols (OFDM symbols (Oss)).

In another implementation, the number of available subbands may be obtained by indicating a value of N. For example, if N=7, then M=8, that is, the number of available subbands is 8, and each bit indicates a transmission direction of a time-frequency resource on a 10 MHz subband in two slots. A value of 0 or 1 of each bit respectively represents an uplink transmission direction or a downlink transmission direction.

It can be learned from the technical solutions in the foregoing embodiment that, in this embodiment of this application, the second information is carried in a combination of a plurality of messages, so that the information about the available subband is flexibly indicated to the terminal, thereby increasing system flexibility, better meeting an actual requirement, and improving resource utilization.

The information transmission method provided in this embodiment of this application may be executed by an information transmission apparatus. In this embodiment of this application, that the information transmission apparatus performs the information transmission method is used as an example to describe the information transmission apparatus provided in this embodiment of this application.

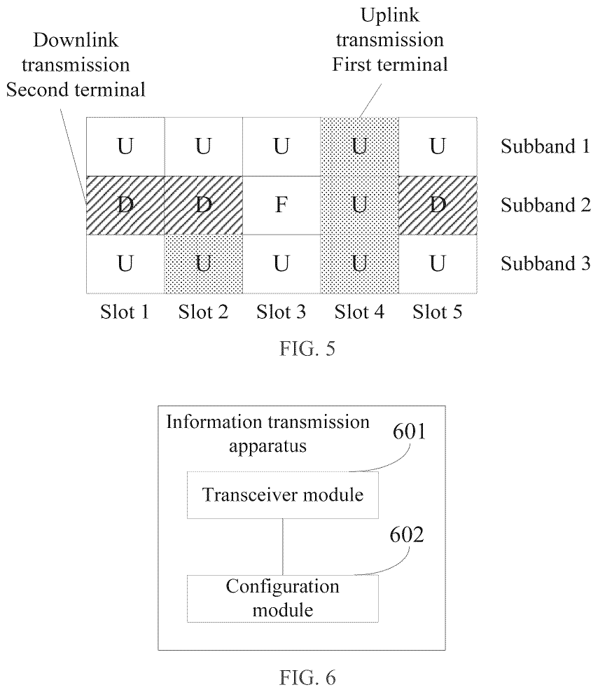

As shown in FIG. 6, the information transmission apparatus includes a transceiver module 601 and a configuration module 602.

The transceiver module 601 is configured to receive first information from a network side device. The configuration module 602 is configured to configure at least one subband based on the first information.

Further, the configuration of the at least one subband includes at least one of the following:

the number of subbands;

frequency domain information of each subband;

frequency domain information of a guard band between adjacent subbands;

an uplink/downlink configuration or a subframe format of each subband; and information about a combination of subbands.

Further, each terminal corresponds to a configuration of the at least one subband of the terminal;

each bandwidth part corresponds to a respective configuration of the at least one subband of the bandwidth part; or

each cell corresponds to a respective configuration of the at least one subband of the cell.

Further, the frequency domain information includes at least one of the following:

a bandwidth or granularity;

a start position in frequency domain; and

an end position in frequency domain.

It can be learned from the technical solutions in the foregoing embodiment that, the network side device in this embodiment of this application configures the configuration of the at least one subband for the apparatus by using the first information. The at least one subband supports separately carrying uplink transmission and downlink transmission at a same time, so that the network side device can separately implement uplink transmission and downlink transmission with a plurality of apparatuses simultaneously, thereby improving resource utilization efficiency and reducing a reply delay of data.

Based on the foregoing embodiment, further, the transceiver module is further configured to:

receive second information from the network side device, where the second information indicates an available subband in the at least one subband; and

send data on a resource that is in the available subband and that is for uplink transmission; and/or receive data on a resource that is in the available subband and that is for downlink transmission.

Further, the second information includes at least one of the following:

first indication information indicating the number of available subbands;

second indication information indicating frequency domain information of the available subbands;

third indication information indicating frequency domain information of a guard band between adjacent subbands in the available subbands;

fourth indication information indicating an uplink/downlink configuration or a subframe format of each of the available subbands; and

fifth indication information indicating information about a combination of the available subbands.

Further, the frequency domain information includes at least one of the following:

a bandwidth or granularity;

a start position in frequency domain; and

an end position in frequency domain.

It can be learned from the technical solutions in the foregoing embodiment that, the network side device in this embodiment of this application indicates the information about the available subband to the apparatus by using the second information, so that the apparatus sends the data based on the resource that is in the available subband and that is for uplink transmission or receives the data based on the resource that is in the available subband and that is for downlink transmission. Therefore, the network side device can separately implement uplink transmission and downlink transmission with a plurality of apparatuses at a same time, thereby improving resource utilization efficiency and reducing a reply delay.

Based on the foregoing embodiment, further, the second information is carried in at least one of the following:

a radio resource control message; and

downlink control information.

Further, indication information included in the second information is respectively carried in a plurality of signaling messages.

It can be learned from the technical solutions in the foregoing embodiment that, in this embodiment of this application, the second information is carried in a combination of a plurality of messages, so that the information about the available subband is flexibly indicated, thereby increasing system flexibility, better meeting an actual requirement, and improving resource utilization.

The information transmission apparatus in this embodiment of this application may be an electronic device, for example, an electronic device having an operating system, or may be a component, such as an integrated circuit or a chip, in an electronic device. The electronic device may be a terminal, or another device other than the terminal. For example, the terminal may include but is not limited to the foregoing listed types of the terminal 11. The another device may be a server, a Network Attached Storage (NAS), or the like. This is not specifically limited in the embodiments of this application.

The information transmission apparatus provided in this embodiment of this application can implement the processes implemented in the method embodiments in FIG. 2 to FIG. 5, and achieve a same technical effect. To avoid repetition, details are not described herein again.

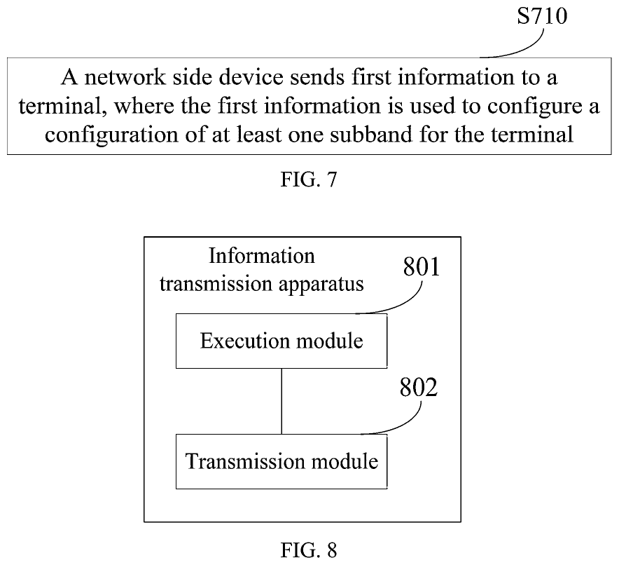

As shown in FIG. 7, an embodiment of this application further provides an information transmission method. The method may be performed by a network side device. In other words, the method may be performed by software or hardware installed in the network side device. The method may include the following step.

S710: The network side device sends first information to a terminal, where the first information is used to configure a configuration of at least one subband for the terminal.

The at least one subband supports separately carrying uplink transmission and downlink transmission at a same time. In some embodiments, one subband may support separately carrying uplink transmission and downlink transmission at a same time. A plurality of subbands may jointly support carrying uplink transmission and downlink transmission at a same time, for example, a subband 1 carries uplink transmission at a time, and a subband 2 carries downlink transmission at this time.

Further, the configuration of the at least one subband includes at least one of the following:

the number of subbands;

frequency domain information of each subband;

frequency domain information of a guard band between adjacent subbands;

an uplink/downlink configuration or a subframe format of each subband; and

information about a combination of subbands.

Further, each terminal corresponds to a configuration of the at least one subband of the terminal;

each bandwidth part corresponds to a respective configuration of the at least one subband of the bandwidth part; or

each cell corresponds to a respective configuration of the at least one subband of the cell.

Further, the frequency domain information includes at least one of the following:

a bandwidth or granularity;

a start position in frequency domain; and

an end position in frequency domain.

The step S710 in FIG. 7 can implement the method embodiment of S210 shown in FIG. 2, and obtain a same technical effect. Repeated parts are not described herein again.

It can be learned from the technical solutions in the foregoing embodiment that, the network side device in this embodiment of this application configures the configuration information of the at least one subband for the terminal by using the first information. The at least one subband supports separately carrying uplink transmission and downlink transmission at a same time, so that the network side device can separately implement uplink transmission and downlink transmission with a plurality of terminals simultaneously, thereby improving resource utilization efficiency and reducing a reply delay of data.

Based on the foregoing embodiment, further, after S710, the method further includes the following steps.

The network side device sends second information to the terminal, where the second information indicates an available subband in the at least one subband.

The network side device receives, from the terminal, data on a resource that is in the available subband and that is for uplink transmission; and/or sends, to the terminal, data on a resource that is in the available subband and that is for downlink transmission.

Further, the second information includes at least one of the following:

first indication information indicating the number of available subbands;

second indication information indicating frequency domain information of the available subbands;

third indication information indicating frequency domain information of a guard band between adjacent subbands in the available subbands;

fourth indication information indicating an uplink/downlink configuration or a subframe format of each of the available subbands; and

fifth indication information indicating information about a combination of the available subbands.

Further, the frequency domain information includes at least one of the following:

a bandwidth or granularity;

a start position in frequency domain; and

an end position in frequency domain.

This embodiment of this application can implement the method embodiment of S220 and S230 shown in FIG. 3, and obtain a same technical effect. Repeated parts are not described herein again.

It can be learned from the technical solutions in the foregoing embodiment that, the network side device in this embodiment of this application indicates the information about the available subband to the terminal by using the second information, so that the terminal sends the data based on the resource that is in the available subband and that is for uplink transmission, or receives the data based on the resource that is in the available subband and that is for downlink transmission. Therefore, the network side device can separately implement uplink transmission and downlink transmission with a plurality of terminals simultaneously, thereby improving resource utilization efficiency and reducing a reply delay.

Based on the foregoing embodiment, further, the second information is carried in at least one of the following:

a radio resource control message; and

downlink control information.

Further, indication information in the second information is respectively carried in a plurality of signaling messages.

It can be learned from the technical solutions in the foregoing embodiment that, in this embodiment of this application, the second information is carried in a combination of a plurality of messages, so that the information about the available subband is flexibly indicated to the terminal, thereby increasing system flexibility, better meeting an actual requirement, and improving resource utilization.

The information transmission method provided in this embodiment of this application may be executed by an information transmission apparatus. In this embodiment of this application, that the information transmission apparatus performs the information transmission method is used as an example to describe the information transmission apparatus provided in this embodiment of this application.

As shown in FIG. 8, the information transmission apparatus includes an execution module 801 and a sending module 802.

The execution module 801 is configured to determine first information, where the first information includes a configuration of at least one subband. The sending module 802 is configured to send first information to a terminal.

Further, the configuration of the at least one subband includes at least one of the following:

the number of subbands;

frequency domain information of each subband;

frequency domain information of a guard band between adjacent subbands;

an uplink/downlink configuration or a subframe format of each subband; and

information about a combination of subbands.

Further, each terminal corresponds to a configuration of the at least one subband of the terminal;

each bandwidth part corresponds to a respective configuration of the at least one subband of the bandwidth part; or

each cell corresponds to a respective configuration of the at least one subband of the cell.

Further, the frequency domain information includes at least one of the following:

a bandwidth or granularity;

a start position in frequency domain; and

an end position in frequency domain.

It can be learned from the technical solutions in the foregoing embodiment that, in this embodiment of this application, the configuration information of the at least one subband is configured for the terminal by using the first information. The at least one subband supports separately carrying uplink transmission and downlink transmission at a same time, so that uplink transmission and downlink transmission with a plurality of terminals can be separately implemented simultaneously, thereby improving resource utilization efficiency and reducing a reply delay of data.

Based on the foregoing embodiment, further, the sending module 802 is further configured to:

send second information to the terminal, where the second information indicates an available subband in the at least one subband; and

receive, from the terminal, data on a resource that is in the available subband and that is for uplink transmission; and/or send, to the terminal, data on a resource that is in the available subband and that is for downlink transmission.

Further, the second information includes at least one of the following:

first indication information indicating the number of available subbands;

second indication information indicating frequency domain information of the available subbands;

third indication information indicating frequency domain information of a guard band between adjacent subbands in the available subbands;

fourth indication information indicating an uplink/downlink configuration or a subframe format of each of the available subbands; and

fifth indication information indicating information about a combination of the available subbands.

Further, the frequency domain information includes at least one of the following:

a bandwidth or granularity;

a start position in frequency domain; and

an end position in frequency domain.

It can be learned from the technical solutions in the foregoing embodiment that, in this embodiment of this application, the information about the available subband is indicated to the terminal by using the second information, so that the terminal sends the data based on the resource that is in the available subband and that is for uplink transmission, or receives the data based on the resource that is in the available subband and that is for downlink transmission. Therefore, uplink transmission and downlink transmission with a plurality of terminals can be separately implemented simultaneously, thereby improving resource utilization efficiency and reducing a reply delay.

Based on the foregoing embodiment, further, the second information is carried in at least one of the following:

a radio resource control message; and

downlink control information.

Further, indication information included in the second information is respectively carried in a plurality of signaling messages.

It can be learned from the technical solutions in the foregoing embodiment that, in this embodiment of this application, the second information is carried in a combination of a plurality of messages, so that the information about the available subband is flexibly indicated to the terminal, thereby increasing system flexibility, better meeting an actual requirement, and improving resource utilization.

The information transmission apparatus in this embodiment of this application may be an electronic device, for example, an electronic device having an operating system, or may be a component, such as an integrated circuit or a chip, in an electronic device. The electronic device may be a terminal, or another device other than the terminal. For example, the terminal may include but is not limited to the foregoing listed types of the terminal 11. The another device may be a server, an NAS, or the like. This is not specifically limited in the embodiments of this application.

The information transmission apparatus provided in this embodiment of this application can implement the processes implemented in the method embodiment in FIG. 7, and achieve a same technical effect. To avoid repetition, details are not described herein again.

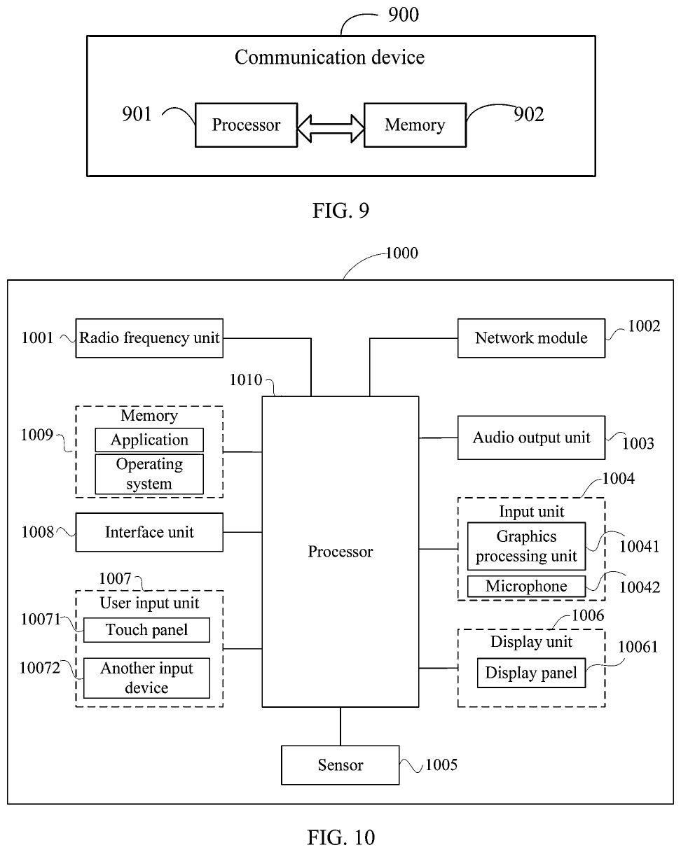

For example, as shown in FIG. 9, an embodiment of this application further provides a communication device 900, including a processor 901 and a memory 902. The memory 902 stores a program or an instruction that can be run on the processor 901. For example, when the communication device 900 is a terminal, and when the program or the instruction is executed by the processor 901, the steps of the foregoing information transmission method embodiment are implemented, and a same technical effect can be achieved. When the communication device 900 is a network side device, and when the program or the instruction is executed by the processor 901, the steps of the foregoing information transmission method embodiment are implemented, and a same technical effect can be achieved. To avoid repetition, details are not described herein again.

An embodiment of this application further provides a terminal, including a processor and a communication interface. The processor is configured to configure configuration information of at least one subband based on the first information. The at least one subband supports separately carrying uplink transmission and downlink transmission at a same time, and the communication interface is used by a network side device to receive the first information. The terminal embodiment corresponds to the foregoing terminal side method embodiment. The implementation processes and the implementations of the foregoing method embodiment can be applied to the terminal embodiment, and a same technical effect can be achieved. For example, FIG. 10 is a diagram of a hardware structure of a terminal according to an embodiment of this application.

A terminal 1000 includes but is not limited to at least a part of components of the following: a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from the network side device, the radio frequency unit 1001 sends the downlink data to the processor 1010 for processing. In addition, the radio frequency unit 1001 may send uplink data to the network side device. Generally, the radio frequency unit 1001 includes but is not limited to an antenna, an amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may be a volatile memory or a non-volatile memory, or the memory 1009 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch Link DRAM (SLDRAM), and a Direct Rambus RAM (DRRAM). The memory 1009 in this embodiment of this application includes but is not limited to these memories and any memory of another proper type.

The processor 1010 may include one or more processing units. In some embodiments, an application processor and a modem processor are integrated into the processor 1010. The application processor mainly processes an operating system, a user interface, an application, or the like. The modem processor mainly processes a wireless communication signal, for example, a baseband processor. It may be understood that, the modem processor may not be integrated into the processor 1010.

The radio frequency unit 1001 is configured to receive the first information from the network side device.

The processor 1010 is configured to configure at least one subband based on the first information.

Further, the configuration of the at least one subband includes at least one of the following:

the number of subbands;

frequency domain information of each subband;

frequency domain information of a guard band between adjacent subbands;

an uplink/downlink configuration or a subframe format of each subband; and

information about a combination of subbands.

Further, each terminal corresponds to a configuration of the at least one subband of the terminal;

each bandwidth part corresponds to a respective configuration of the at least one subband of the bandwidth part; or

each cell corresponds to a respective configuration of the at least one subband of the cell.

Further, the frequency domain information includes at least one of the following:

a bandwidth or granularity;

a start position in frequency domain; and

an end position in frequency domain.

The network side device in this embodiment of this application can separately implement uplink transmission and downlink transmission with a plurality of apparatuses simultaneously, thereby improving resource utilization efficiency and reducing a reply delay of data.

Based on the foregoing embodiment, further, the radio frequency unit 1001 is further configured to:

receive second information from the network side device, where the second information indicates an available subband in the at least one subband; and

send data on a resource that is in the available subband and that is for uplink transmission; and/or receive data on a resource that is in the available subband and that is for downlink transmission.

Further, the second information includes at least one of the following:

first indication information indicating the number of available subbands;

second indication information indicating frequency domain information of the available subbands;

third indication information indicating frequency domain information of a guard band between adjacent subbands in the available subbands;

fourth indication information indicating an uplink/downlink configuration or a subframe format of each of the available subbands; and

fifth indication information indicating information about a combination of the available subbands.

Further, the frequency domain information includes at least one of the following:

a bandwidth or granularity;

a start position in frequency domain; and

an end position in frequency domain.

The network side device in this embodiment of this application can separately implement uplink transmission and downlink transmission with a plurality of apparatuses simultaneously, thereby improving resource utilization efficiency and reducing a reply delay.

Based on the foregoing embodiment, further, the second information is carried in at least one of the following:

a radio resource control message; and

downlink control information.

Further, indication information included in the second information is respectively carried in a plurality of signaling messages.

It can be learned from the technical solutions in the foregoing embodiment that, in this embodiment of this application, the second information is carried in a combination of a plurality of messages, so that the information about the available subband is flexibly indicated, thereby increasing system flexibility, better meeting an actual requirement, and improving resource utilization.

An embodiment of this application further provides a network side device, including a processor and a communication interface. The processor is configured to determine first information, where the first information includes a configuration of at least one subband, and the communication interface is configured to send first information to a terminal. The network side device embodiment corresponds to the foregoing method embodiment of the network side device. The implementation processes and the implementations of the foregoing method embodiment can be applied to the network side device embodiment, and a same technical effect can be achieved.

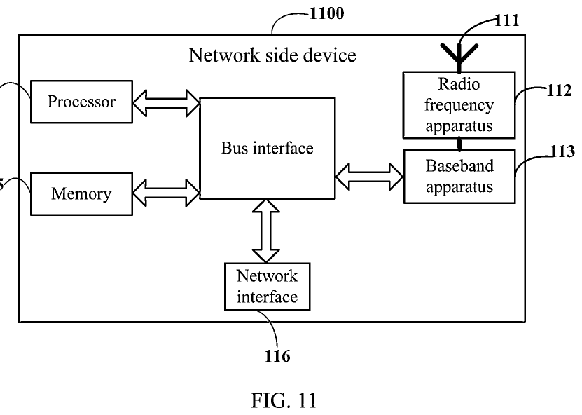

For example, an embodiment of this application further provides a network side device. As shown in FIG. 11, a network side device 1100 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information through the antenna 111, and sends the received information to the baseband apparatus 113 for processing. In a downlink direction, the baseband apparatus 113 processes to-be-sent information, and sends processed information to the radio frequency apparatus 112. The radio frequency apparatus 112 processes the received information, and sends processed information through the antenna 111.

In the foregoing embodiment, the method performed by the network side device may be implemented in the baseband apparatus 113. The baseband apparatus 113 includes a baseband processor.

For example, the baseband apparatus 113 may include at least one baseband board. A plurality of chips are disposed on the baseband board. As shown in FIG. 11, one chip is, for example, a baseband processor, and is connected to the memory 115 through a bus interface, to invoke a program in the memory 115 to perform the operations of the network device shown in the foregoing method embodiment.

The network side device may further include a network interface 116, and the interface is, for example, a Common Public Radio Interface (CPRI).

For example, the network side device 1100 in this embodiment of this application further includes an instruction or a program that is stored in the memory 115 and that can be run on the processor 114. The processor 114 invokes the instruction or the program in the memory 115 to perform the method performed by the modules shown in FIG. 8, and a same technical effect is achieved. To avoid repetition, details are not described herein again.

An embodiment of this application further provides a readable storage medium. The readable storage medium stores a program or an instruction, and when the program or the instruction is executed by a processor, the processes of the foregoing information transmission method embodiment are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor, and the processor is configured to run a program or an instruction to implement the processes of the foregoing information transmission method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing information transmission method embodiment, and a same technical effect can be achieved. To avoid repetition, details are not described herein again.

An embodiment of this application further provides an information transmission system, including a terminal and a network side device. The terminal may be configured to perform the steps of the information transmission method as described above, and the network side device may be configured to perform the steps of the information transmission method as described above.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

1. An information transmission method, comprising:
receiving, by a terminal, first information from a network side device, wherein the first information comprises a configuration of at least one subband.

2. The information transmission method according to claim 1, wherein the configuration of the at least one subband comprises at least one of the following:
the number of subbands;
frequency domain information of each subband;
frequency domain information of a guard band between adjacent subbands;
an uplink/downlink configuration or a subframe format of each subband; or information about a combination of subbands.

3. The information transmission method according to claim 1, wherein after receiving the first information, the method further comprises:
receiving, by the terminal, second information from the network side device, wherein the second information indicates an available subband in the at least one subband; and
sending, by the terminal, data on a resource that is in the available subband and that is for uplink transmission, or receiving, by the terminal, data on a resource that is in the available subband and that is for downlink transmission.

4. The information transmission method according to claim 3, wherein the second information comprises at least one of the following:
first indication information indicating the number of available subbands;
second indication information indicating frequency domain information of the available subbands;
third indication information indicating frequency domain information of a guard band between adjacent subbands in the available subbands;
fourth indication information indicating an uplink/downlink configuration or a subframe format of each of the available subbands; or
fifth indication information indicating information about a combination of the available subbands.

5. The information transmission method according to claim 2, wherein the frequency domain information comprises at least one of the following:
a bandwidth or granularity;
a start position in frequency domain; or
an end position in frequency domain.

6. The information transmission method according to claim 3, wherein the second information is carried in at least one of the following:
a radio resource control message; or
downlink control information.

7. The information transmission method according to claim 4, wherein indication information comprised in the second information is respectively carried in a plurality of signaling messages.

8. The information transmission method according to claim 1, wherein each terminal corresponds to a respective configuration of the at least one subband of the terminal;
each bandwidth part corresponds to a respective configuration of the at least one subband of the bandwidth part; or
each cell corresponds to a respective configuration of the at least one subband of the cell.

9. An information transmission method, comprising:
sending, by a network side device, first information to a terminal, wherein the first information is used to configure a configuration of at least one subband for the terminal.

10. The information transmission method according to claim 9, wherein the configuration of the at least one subband comprises at least one of the following:
the number of subbands;
frequency domain information of each subband;
frequency domain information of a guard band between adjacent subbands;
an uplink/downlink configuration or a subframe format of each subband; or
information about a combination of subbands.

11. The information transmission method according to claim 9, wherein after sending the first information to the terminal, the method further comprises:
sending, by the network side device, second information to the terminal, wherein the second information indicates an available subband in the at least one subband; and
receiving, by the network side device from the terminal, data on a resource that is in the available subband and that is for uplink transmission; or sending, by the network side device to the terminal, data on a resource that is in the available subband and that is for downlink transmission.

12. The information transmission method according to claim 11, wherein the second information comprises at least one of the following:
first indication information indicating the number of available subbands;
second indication information indicating frequency domain information of the available subbands;
third indication information indicating frequency domain information of a guard band between adjacent subbands in the available subbands;
fourth indication information indicating an uplink/downlink configuration or a subframe format of each of the available subbands; or
fifth indication information indicating information about a combination of the available subbands.

13. A terminal, comprising: a processor; and a memory having a computer program or an instruction stored thereon, wherein the computer program or the instruction, when executed by the processor, causes the processor to perform operations, comprising:
receiving first information from a network side device, wherein the first information comprises a configuration of at least one subband.

14. The terminal according to claim 13, wherein the configuration of the at least one subband comprises at least one of the following:
the number of subbands;
frequency domain information of each subband;
frequency domain information of a guard band between adjacent subbands;
an uplink/downlink configuration or a subframe format of each subband; or
information about a combination of subbands.

15. The terminal according to claim 13, wherein after receiving the first information, the operations further comprise:
receiving second information from the network side device, wherein the second information indicates an available subband in the at least one subband; and
sending data on a resource that is in the available subband and that is for uplink transmission, or receiving data on a resource that is in the available subband and that is for downlink transmission.

16. The terminal according to claim 15, wherein the second information comprises at least one of the following:
first indication information indicating the number of available subbands;
second indication information indicating frequency domain information of the available subbands;
third indication information indicating frequency domain information of a guard band between adjacent subbands in the available subbands;
fourth indication information indicating an uplink/downlink configuration or a subframe format of each of the available subbands; or
fifth indication information indicating information about a combination of the available subbands.

17. The terminal according to claim 15, wherein the frequency domain information comprises at least one of the following:
a bandwidth or granularity;
a start position in frequency domain; or
an end position in frequency domain.

18. The terminal according to claim 15, wherein the second information is carried in at least one of the following:
a radio resource control message; or
downlink control information.

19. The terminal according to claim 16, wherein indication information comprised in the second information is respectively carried in a plurality of signaling messages.

20. The terminal according to claim 13, wherein each terminal corresponds to a respective configuration of the at least one subband of the terminal;
each bandwidth part corresponds to a respective configuration of the at least one subband of the bandwidth part; or
each cell corresponds to a respective configuration of the at least one subband of the cell.
